(19) United States
(12) Patent Application Publication
(10) Pub. No.: US 2025/0010652 A1
(43) Pub. Date: Jan. 9, 2025

(54) SECURITY FEATURE FOR AN IDENTIFICATION DOCUMENT, IDENTIFICATION DOCUMENT AND METHOD FOR PRODUCING A SECURITY FEATURE

(71) Applicant: GIESECKE+DEVRIENT EPAYMENTS GMBH, Munchen (DE)

(72) Inventors: Josef RIEDL, Attenkirchen (DE); Gunter ENDRES, Passau (DE); Klaus KOHL, Miesbach (DE); Cristina FABIAN, Garching (DE)

(21) Appl. No.: 18/710,068

(22) PCT Filed: Nov. 23, 2022
(86) PCT No.: PCT/EP2022/025534

§ 371 Date: May 14, 2024

(30) Foreign Application Priority Data
Nov. 26, 2021 (DE) 10 2021 005 870.4

(51) Int. Cl. B42D 25/378; B42D 25/23; B42D 25/435

(52) U.S. Cl. CPC B42D 25/378; B42D 25/23; B42D 25/435

(57) ABSTRACT

A security feature for an identification document having a film, into the volume of which optically variable pigments are introduced, and a marking which extends at least over a portion of the optically variable pigments, at least a portion of the pigments being carbonized.

### BACKGROUND

The invention relates to a security feature for an identification document, to an identification document and to a method for producing a security feature.

Identification documents or data carriers, for example passport and identity documents, identity cards, credit cards, bank cards and the like, are being used to an increasing extent in public sectors, as well as in the company in-house sector.

The use of printed inks with pigments based on metal oxides, which impart for example a pearlescent luster, is known. Further known are optically variable security elements whose representation changes with a change in the observation angle. The basic concept is improved by using optically variable inks (OVI inks). OVI inks are conventionally applied by a printing method, for example screen printing. One difficulty results from the fact that such OVI inks are inclined to flake or form bubbles when lasered with high energy.

US20210150296 A1 discloses an authentication medium, particularly in the form of a card, in which an item of personal identification information is formed in a lamination layer. The item of identification information may be applied onto the lamination layer in the form of an invisible optically variable ink that is made visible with the aid of a laser.

EP 2174797 A1 discloses for security documents the use of optically variable effect pigments applied in an ink and the treatment thereof with a laser. The laser treatment modifies the visual appearance of the effect pigments, and in particular darkens them.

### SUMMARY

It is therefore an object of the present invention to improve the processing of OVI inks with a laser.

A security feature according to the invention for an identification document comprises a film having at least one marking with optically variable pigments, at least a portion of which is carbonized.

A basic concept of the present invention is that optically variable (OVI) pigments are introduced into a film. It is proposed not to print the OVI pigments but to integrate them into the volume of a film. The correspondingly prepared film is integrated into the card body structure.

The security feature proposed here with an optical marking, for example a portrait, therefore has the advantage that blackening of the OVI ink by means of a laser is possible for the first time. Lasering with high energy is used until carbonization or thermal breakdown of the OVI pigments, also referred to as burning. The OVI pigments can act as a laser additive in a transparent or translucent film, and are carbonized under the laser action. To date, in the case of OVI inks it has been possible only to ablate with low energy by means of a laser. The ablation only removes or modifies an upper layer of the OVI ink.

The incorporation of the OVI pigments in the film enables blackening of the OVI ink without loss of cohesion or damage in the sense of bursting. The protection against forgery can also be increased since the pigments are inside the film.

It may be provided that a further portion of the optically variable pigments is ablated. Further optical effects may thus be generated when some portions of the optically variable pigments in a security feature are carbonized and further portions of the optically variable pigments are ablated. The same laser may be used with lower energy for the ablation.

It may further be provided that the film is formed as an inlay in a recess. The spatial extent may in this case be less than with a surface-wide film. In the case of an inlay, the film may already be a component of the film composite.

It may be provided that one or more overlay films, which contains or contain laser additives, are arranged on the film. By means of the laser additives, both the production of the security feature may be varied and also effects may be achieved when observing the security feature, and the blackening may be improved.

It may further be provided that thermoplastics as well as all recyclable thermoplastics, preferentially PC, PETG, PET, PVC, ABS, PS, PLA, polyolefins or thermoplastics from renewable raw materials, and particularly preferentially polycarbonate or polyester, are provided as the material or carrier material of the film. OVI pigments can readily be introduced into these materials.

It may be provided that the film has a thickness of 50-840 μm, preferentially 75-700 μm and particularly preferentially 100-600 μm. These thicknesses or widths of the film allow good processing.

It may further be provided that a pigment concentration of from 0.1% to 3%, preferentially 0.2% to 2% and particularly preferentially 0.3% to 1% is provided, expressed in terms of the weight of the total film formulation.

It may be provided that a pigment size of 10-150 μm, preferentially 20-120 μm and particularly preferentially 25-100 μm is provided. This pigment size is highly suitable for processing, irradiation by the laser and also for representation of the marking.

It may further be provided that the marking is a biometric representation, comprises personalized data, such as a signature, a date of birth, a portrait or the like, or comprises data relating to the identification document, such as a term of validity, a card number, indication of the issuing authority or the like. In principle, all graphically representable elements consisting of individual pixels, which can be carbonized by laser irradiation, may be represented.

An identification document according to the invention, such as an identification card, a document of value, bank bill or the like, comprises a substrate with a substrate on or in which a security feature as described above is at least partially arranged.

The security feature may, for example, be arranged fully in an opening or recess as an inlay. The opening with the security feature located therein may, for example, be covered by means of one or more films and then laminated. In other regards, the same advantages and modifications as described above apply.

A method according to the invention for producing a security feature for an identification document comprises the steps:
providing a film having at least one marking with optically variable pigments, and
carbonizing at least a portion of the optically variable pigments with a laser beam.

The film with the OVI pigments contained therein may, for example, be produced by a granulate mixture of the OVI pigments and granulate of the carrier material of the film being heated and extruded to form a film. In other regards, the same advantages and modifications as described above apply.

It may be provided that the pigments are generated by means of physical vapor deposition. The pigments may thus be generated easily.

### BRIEF DESCRIPTION OF THE DRAWINGS

The present invention will be described by way of example below with reference to the appended drawings, in which:

FIG. 1 shows a plan view of an identification document;

FIGS. 2a and 2b show basic sectional representations of the identification document of FIG. 1 according to the line I-I;

FIGS. 3a and 3b show an outline representation of a security feature with carbonized optically variable pigments; and

FIG. 4 shows a method for producing a security feature for an identification document.

### DETAILED DESCRIPTION OF VARIOUS EMBODIMENTS

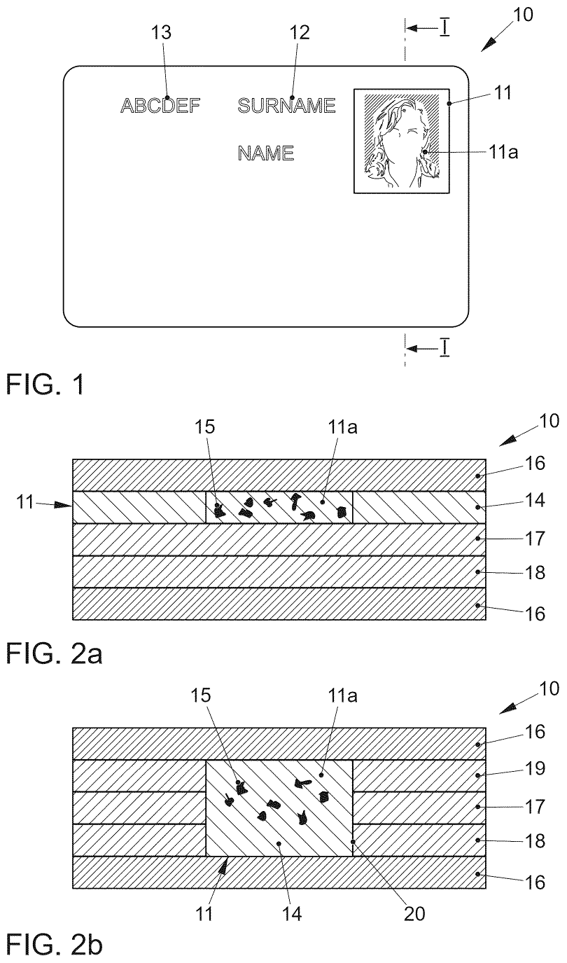

FIG. 1 shows a view of an identification document 10 in a schematic representation. The identification document 10 may be a bank bill, a passport and identity document or the like. In the example represented in FIG. 1, the identification document 10 is an identity document. A bank bill may also be a hybrid bank bill or a polymer bank bill, or for example only the LEAD strip of a bank bill.

The identification document 10 contains a security feature 11, here as an example in the form of a portrait of the cardholder as well as further personalized data 12, for example the first name and surname of the holder. The identification document 10 may also contain further data 13 such as date of birth, nationality, issuing authority, issue date and the like. The security feature 11 may be arranged fully or partially in an opening or recess 20 of the identification document 10 or may be laminated as an intermediate layer in the identification document 10.

A tilt-shift image may be formed in the security feature 11, which contains for example two different items of information, each inscribed by means of a laser beam, in the form of a first marking and a second marking. The two markings can be seen by an observer at different angles. In the example, both markings are expediently part of the security feature 11, or form the security feature 11.

The basic structure of the security feature 11 will now be explained in more detail with reference to FIG. 2a and FIG. 2b, which show a section through the identification document 10 along the line I-I of FIG. 1.

FIG. 2a shows by way of example an identification document 10 with a 5-layer structure. Identification documents with more or fewer layers may also be envisioned.

The security feature 11 comprises a film of 14 with at least one marking 11a. Optically variable pigments (OVI) 15, the optical properties of which, for example color or intensity, depend on an observation angle, are introduced into the volume of the film 14. The marking 11a extends at least over a portion of the optically variable pigments 15. Besides the marking 11a, it is possible to provide another marking or several further markings. This or these further markings may be formed in a similar way to the marking 11a at another location in the film 14. For example, the marking 11a may be a portrait and a further marking may comprise text, for instance the name.

In the film 14, a portion of the optically variable pigments 15 is carbonized at least in the region of the marking 11a. This has the effect that this portion of the marking 11a appears black. By the carbonizing or burning of a portion of the optically variable pigments 15, a portion of the marking 11a is blackened in this portion or region. This is done by means of a laser, for example an Nd:YAG laser.

The film 14 with the optically variable pigments 15 may be arranged on any desired layer in the card body, surface-wide or in subregions. In the representation of FIG. 2a, the film 14 is represented at a second position in the viewing direction. The film 14 may also be arranged at a third, fourth or fifth position. The film 14 may also be arranged as an overlay film. In this case, the film 14 is lasered directly. The blackening achieved is then generally somewhat less strong. Furthermore, multiple introduction of the film 14 into an identification document 10 is possible.

The film 14 is transparent or translucent, i.e. partially transmits light. It is also conceivable that the optically variable pigments 15 are introduced so densely that the film 14 appears opaque; in such a case, the film 14 itself may also be opaque or nearly opaque. The film 14 may comprise thermoplastics as well as all recyclable thermoplastics, preferentially PC, PETG, PET, PVC, ABS, PS, PLA, polyolefins or thermoplastics from renewable raw materials, and particularly preferentially polycarbonate or polyester, as its material.

The film 14 may have a thickness of 50-840 μm, preferentially 75-700 μm and particularly preferentially 100-600 μm.

The optically variable pigments 15 may be provided in the film 14 in a pigment concentration of from 0.1% to 3%, preferentially 0.2% to 2% and particularly preferentially 0.3% to 1%, in percentages by weight expressed in terms of the weight of the total formulation of the film 14.

The optically variable pigments 15 may be provided in the film 14 in a pigment size of 10-150 μm, preferentially 20-120 μm and particularly preferentially 25-100 μm.

The film 14 may be provided with additional laser additives in order to improve the blackening achieved. This may be suitable particularly when the film 14 is configured as an overlay.

The card body, represented in FIG. 2a, of the identification document 10 has two overlay films or cover layers 16. The film 14 with the optically variable pigments 15 integrated into the film 14, as well as a film 17 and a further film 18, are arranged between the two cover layers 16. The two films 17 and 18 may, for example, be protective layers or functional layers provided with other security elements. Each of the layers 16, 17 and 18 may contain laser additives in order to control the laser processing.

FIG. 2b shows a card body of the identification document 10, in which the film 14 with the optically variable pigments 15 is configured as an inlay.

An opening or recess 20 for the film 14 is formed in the layers or films 17, 18 and 19. The film 14 is laminated with the films 17, 18 and 19 between the cover layers 16. The film 14 configured as an inlay may have a smaller extent and a greater thickness in comparison with the film represented in FIG. 2a. The optical properties may be identical.

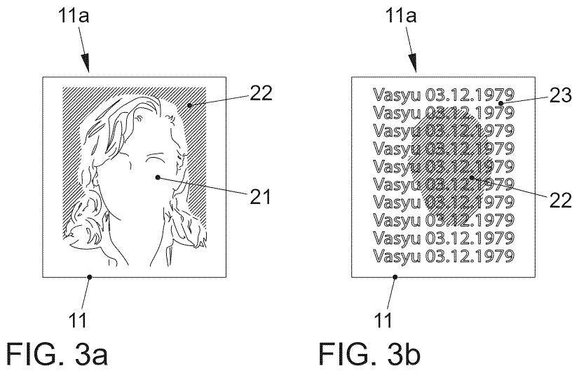

FIGS. 3a and 3b respectively show an outline representation of a security feature 11 partially with carbonized optically variable pigments.

FIG. 3a represents the security feature 11 with a marking 11a in the form of a portrait. As described above, the security feature 11 or the marking 11a is a component of the film 14.

The security feature 11, or the marking 11a, comprises optically variable pigments (OVI) 15. In an unblackened region 21, the optically variable pigments 15 have not been treated with a laser, or at least have been treated only with a low energy. This low energy leads only to ablation of the color pigments, or the optically variable pigments 15, but not to their carbonization or thermal breakdown. For example, the hue that the payments 15 inherently have may be lightened by ablation. Carbonization or thermal breakdown, conversely, cause blackening of marking 11a.

In a blackened region 22, the optically variable pigments 15 have been treated by a laser with high energy. This high energy—for example in a range of 5-100 mJ when using an Nd:YAG laser—is set in such a way that carbonization or thermal breakdown of the optically variable pigments 15 is achieved, which leads to blackening. Correspondingly, the blackened region 22 is blackened. Since the optically variable pigments 15 are arranged in the volume of the film 14, even the high input of energy by the laser, which is used for the carbonization, does not lead to loss of cohesion or bursting.

In this example, the blackened region 22 with carbonized optically variable pigments 15 is formed in the background of the portrait, while the portrait has no blackenings except for contour lines. Nevertheless, it is likewise possible for a portion of the portrait to be carbonized.

FIG. 3b likewise shows a security feature 11 with a marking 11a formed from graphic and alphanumeric elements. As described above, the marking 11a is a component of the film 14. In this example, a blackened region 22 with carbonized optically variable pigments 15, which may also be a portrait, is formed at the center of the security feature. The background around the blackened central region may, for example, be uncarbonized.

In FIG. 3b, the background around the blackened central region is configured as a partially blackened region 23, in which a portion of the optically variable pigments 15 is carbonized in the form of alphanumeric symbols. The security feature 11 according to FIG. 3b is configured as an MLI (multiple laser image) security feature, which is also referred to as a tilt-shift image. In such a security feature, the view or appearance for an observer changes as a function of the observation angle. This is generated by a laser introducing items of information into the film 14 at different angles. The carbonization may be carried out for all observation planes or image components of the different angles.

In general, by carbonizing pigments in the film 14, it is possible to introduce a first item of information in one of the two regions 22 and 23 and to introduce a second item of information in the other of the two regions 23 and 22.

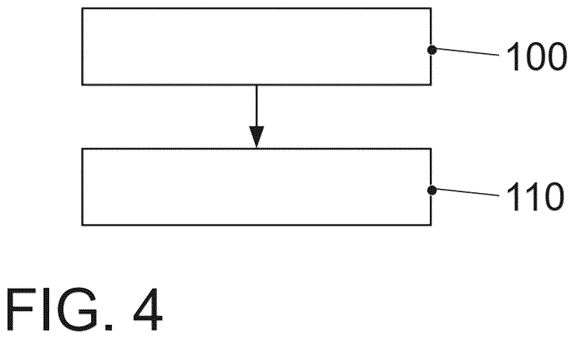

FIG. 4 shows a method for producing a security feature 11 for an identification document 10.

In a first step 100, a film 14 with optically variable pigments 15 introduced into its volume is provided. For example, a granulate mixture of optically variable pigments 15 and a granulate of a carrier material of the film 14 may be melted, and the film 14 may then be extruded from the melt. In the film 14 then obtained, the optically variable pigments 15 are distributed uniformly through the volume of the film 14. For the extrusion, the temperature and the carrier material may be selected in such a way that essentially only the carrier material of the film 14 is melted, so that the optically variable pigments 15 remain unmodified. The film 14 is expediently provided as roll material or in the form of sheets.

In a second step 110, the marking 11a is produced by carbonizing at least a portion of the optically variable pigments 15 with a laser beam, for example of an Nd:YAG laser. Depending on the material and/or the composition of the optically variable pigments 15, of the film 14 and optional intermediate layers, an energy that is sufficient for carbonization of the optically variable pigments 15 is introduced. This energy is greater than the energy that is usual for the ablation. When using an Nd:YAG laser, the applied energy may lie in a range of 5-100 mJ.

By the lasering with high energy until carbonization or thermal breakdown, the optically variable pigments 15 acting as a laser additive are blackened.

The described method is not restricted to optically variable inks (OVI inks). It is in principle likewise suitable for conventional inks based on metal oxides.

1.-12. (canceled)

13. A security feature for an identification document with at least one marking, wherein it has a film, into the volume of which optically variable pigments are introduced, and the at least one marking extends at least over a portion of the optically variable pigments, at least a portion of which is carbonized.

14. The security feature according to claim 13, wherein a further portion of the optically variable pigments is ablated.

15. The security feature according to claim 13, wherein the film is formed as an inlay in a recess.

16. The security feature according to claim 13, wherein an overlay film, which contains laser additives, is arranged on the film.

17. The security feature according to claim 13, wherein thermoplastics as well as all recyclable thermoplastics, selected from the group consisting of: PC, PETG, PET, PVC, ABS, PS, PLA, polyolefins or thermoplastics from renewable raw materials.

18. The security feature according to claim 13, wherein the film has a thickness of 50-840 μm.

19. The security feature according to claim 13, wherein a pigment concentration of from 0.1% to 3% is provided.

20. The security feature according to claim 13, wherein a pigment size of 10-150 μm is provided.

21. The security feature according to claim 13, wherein the marking is a biometric representation, comprises personalized data, or comprises data relating to the identification document.

22. An identification document, having a substrate on or in which a security feature according to claim 13 is at least partially arranged.

23. A method for producing a security feature for an identification document, having the steps:
providing a film, into the volume of which optically variable pigments are introduced, and
carbonizing at least a portion of the optically variable pigments with a laser beam in order to generate a marking.

24. The method according to claim 23, wherein the pigments are generated by means of physical vapor deposition.
